(19) United States
(12) Patent Application Publication
(10) Pub. No.: US 2016/0151241 A1
(43) Pub. Date: Jun. 2, 2016

(54) HIGH RECOVERY VIAL ADAPTOR

(71) Applicant: Allergan, Inc., Irvine, CA (US)

(72) Inventors: David Mucientes, Long Beach, CA (US); Anthony L. Vergel de Dios, Rancho Santa Margarita, CA (US)

(21) Appl. No.: 14/980,156

(22) Filed: Dec. 28, 2015

Related U.S. Application Data
(63) Continuation of application No. 13/590,838, filed on Aug. 21, 2012, now abandoned.
(60) Provisional application No. 61/526,649, filed on Aug. 23, 2011.

(51) Int. Cl. A61J 1/20

(52) U.S. Cl. CPC A61J 1/2051; A61J 1/201

(57) ABSTRACT

Some medicaments, such as botulinum toxin, are sold in small glass vials with a cap that comprises a seal. The seal is punctured to allow liquid to be added to reconstitute the medicament, then allow the medicament to be withdrawn through a needle into a syringe. A substantially larger amount of a liquid medicament may be obtained by using an adaptor device. An adaptor device may have a puncture component that allows a flexible tube to be inserted through the seal at an angle that allows an end of a flexible tube to rest on the bottom on a vial around the edge of the vial. This may allow vial to be tipped so that the liquid pools around the end of the flexible tube, thus significantly increasing the amount of liquid that can be withdrawn.

This application is a continuation of U.S. patent application Ser. No. 13/950,838, filed Aug. 21, 2012 which claims the benefit of U.S. Provisional Patent Application No. 61/526,649, filed on Aug. 23, 2011, the entire disclosure of each of these documents being incorporated herein by this reference.

Many medicaments, for example, botulinum toxin, are sold in small glass vials with a cap that comprises a seal. The seal is puncturable to allow liquid to be added, for example, to reconstitute the medicament. The reconstituted medicament may then be withdrawn through a needle into a syringe.

One disadvantage of this type of packaging may be that the needle and syringe configuration may not be able to draw a significant amount of the liquid in the vial, thus resulting in loss of a significant part of the product. This is especially undesirable when the medicament is expensive.

Improved systems for facilitating efficient withdrawal of liquid medicaments from containers, such as glass vials, would be desirable.

### SUMMARY

Accordingly, an adaptor device for facilitating efficient recovery of fluid from a vial is provided. The device allows a substantially larger, or at least more significant, amount of a liquid medicament to be withdrawn from a vial. Generally, the device includes a puncture component that allows a flexible tube to be inserted through the seal at an angle that allows an end of a flexible tube to rest on the bottom on a vial around the edge of the vial. This may allow vial to be tipped so that the liquid pools around the end of the flexible tube, thus significantly increasing the amount of liquid that can be withdrawn for use.

More specifically, an adaptor device in accordance with one embodiment comprises: a puncture component, a flexible tube, an inserter, and a coupling component. A puncture component may have a cylindrical portion, a proximal end, and a tapered distal end configured to puncture a seal. The puncture component may have a passage comprising: an entrance at or near the proximal end of the puncture component; a interior portion, connected to the entrance, and residing entirely within the puncture component; and an exit, connected to the interior portion so that the interior portion is between the first portion and the exit. In some embodiments, a puncture component may be configured to allow the entrance of the passage and the exit of the passage to be on opposite sides of the seal. An inserter may be coupled to the flexible tube and configured to direct the distal end of the tube through the passage and out of the exit of the passage. A coupling component may be configured to allow fluid communication between the proximal end of the flexible tube and a syringe. The device of any one of the preceding claims, wherein the seal is configured to be punctured by a needle for withdrawal of a medicament through the needle into a syringe.

In some embodiments, the puncture component is configured to allow the entrance of the passage and the exit of the passage to be on opposite sides of the seal.

In some embodiments, the device is configured to allow the flexible tube to be guided through the seal via the puncture component so that the distal end of the flexible tube extends from the exit of the puncture component at an angle that is not perpendicular to the seal.

In another aspect of the invention, a method of recovering a medicament, such as a botulinum toxin, from a vial is provided, the method including the steps of drawing a medicament from the vial using an adaptor device as described herein.

Each and every feature described herein, and each and every combination of two or more of such features, is included within the scope of the present invention provided that the features included in such a combination are not mutually inconsistent.

### BRIEF DESCRIPTION OF THE DRAWINGS

The present invention may be more clearly understood and the advantages thereof better appreciated by considering the below Detailed Description and accompanying Drawings of which:

FIG. 1A is a perspective view of a high recovery adaptor device, in accordance with an embodiment of the invention, being used with a medicament vial having a puncturable seal;

FIG. 1B is another perspective view of the device shown in FIG. 1, with a recovery tube being inserted therein;

FIG. 1C is a cross-sectional view of an angled passageway feature of the device

FIG. 2 is a perspective view of a device, in accordance with an embodiment of the invention, as coupled to a medicament vial;

FIGS. 3 and 3A are cross-sectional views of the device shown in FIG. 2;

FIG. 4 is another cross-sectional view of the device shown in FIG. 2, with a recovery tube inserted therein;

FIG. 5 is a perspective view of another device in accordance with an embodiment of the invention;

FIGS. 6 and 7 are cross-sectional views of the device shown in FIG. 5;

FIG. 8 is a perspective view of yet another device in accordance with an embodiment of the invention;

FIGS. 9 and 10 are cross-sectional views of the device shown in FIG. 8; and

FIGS. 11 and 12 are cross-sectional views of a coupling component feature of certain embodiments of the invention.

### DETAILED DESCRIPTION

Turning now to the Figures, generally, an adaptor device in accordance with the invention, may comprise a puncture component, a flexible tube, an inserter, and a coupling component. While there are many ways the present adaptor may be configured, schematic drawing of some embodiments are shown.

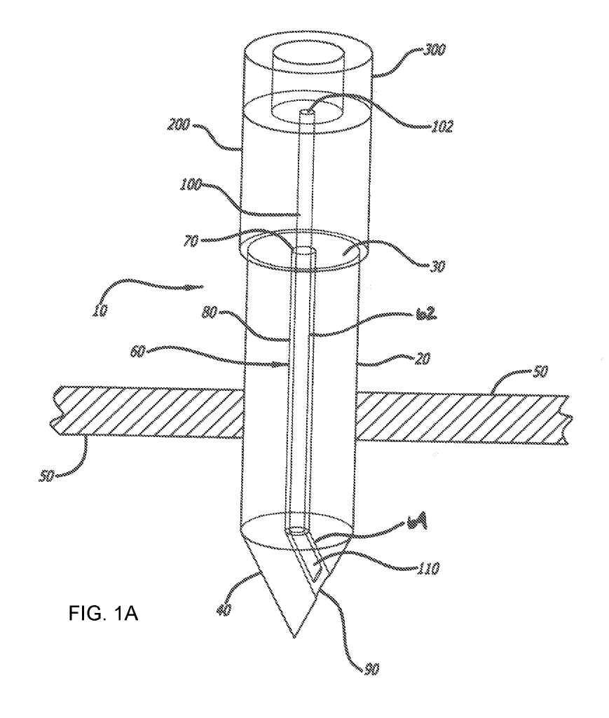

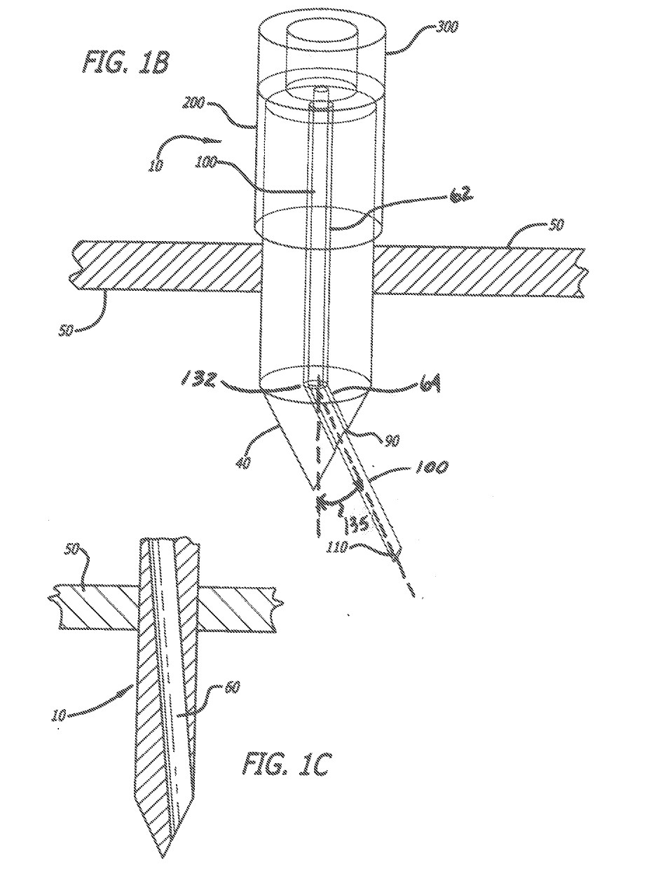

FIGS. 1A and 1B show an adaptor device 8 comprising a puncture component 10, the puncture component 10 being shown penetrating a medicament vial seal 50. The adaptor device 8 may include a flexible conduit or tube 100. The flexible tube 100 has a distal end 110 and a proximal end 102. Tube 100 is shown in a retracted state in FIG. 1A and is shown in an extended state in FIG. 1B.

Puncture component 10 comprise a body 20, for example, a cylindrical body 20, having a proximal end 30, and a tapered distal end 40. Distal end 40 is configured to puncture a seal 50, for example, an existing seal 50 on a medicament container. Such a seal is typically configured to be punctured by a needle or cannula for reconstituting medicament and/ or for withdrawal of medicament through a needle into a syringe. Seal 50 may be a polymer such as a latex or rubber, polytetrafluoroethylene, a polyalkylene, an acrylic, a polyurethane, a polyalkylene, a substituted vinyl polymer, etc.; a foil such as an aluminum foil; paper; cork; etc.

The puncture component 10 includes a passage 60 configured to receiving tube 100. Passage 60 includes an inlet or entrance 70 at or near the proximal end 30 of the puncture component 10. Passage 60 may be defined by interior wall portion 80, connected to the entrance 70, and residing within the puncture component 10. Passage 60 also includes an exit 90 at the distal end of the interior portion 80. When device 8 is in use with puncture component 10 inserted into seal 50 as shown, entrance 70 of the passage 60 and the exit 90 of the passage 60 are generally disposed on opposing sides of the seal 50.

Passage 60 may include an angle such as shown in FIGS. 1A and 1B, such that proximal portion 62 of passage 60 is disposed substantially perpendicular to seal 50, and distal portion 64 of passage 60 is disposed at an angle with respect to proximal portion 62. Alternatively, passage 60 may be substantially entirely linear, without an angle between distal portion and proximal portion, such as depicted in FIG. 1C. Thus, it can be appreciated that passage 60, shown in FIG. 1C would be disposed at an angle other than perpendicular to seal 50.

Unless explicitly stated otherwise, when describing the structure and operation of the device herein, it will be assumed that the entrance 70 of the passage 60 and the exit 90 of the passage 60 are on opposite sides of the seal 50. However, seal 50 itself may not be part of a device or a method described herein.

Tube 100 and passage 60 are generally sized and structured to allow tube 100 to be easily inserted and passed through the full length of passage 60. In certain embodiments, passage 60 has an inner diameter of about 0.1 mm to about 2 mm, and tube 100 has an outer diameter of about 0.05 mm to about 1.5 mm.

More specifically, the puncture component 10 is configured so that when a flexible tube 100 is extended through the passage 60 of the puncture component 10, the distal portion of the flexible tube 100, e.g. the portion of flexible tube 100 between the exit 90 of the passage 60 and the distal end 110 of flexible tube 100, may form an angle that is not perpendicular to the seal 50. Angle of tube 100 guided by passage 60 is sized to direct distal end of tube 100 to a corner of the vial, for example, to enhance recovery of liquid medicament therefrom. When the device 8 is in use for recovering medicament, flexible tube 100 is extended distally through passage 60 such that the distal end 110 of tube 100 may rest on or near the bottom of a vial containing liquid medicament, for example, away from a center of the vial. When the liquid level is low, the vial can be tipped so that the liquid pools around the tube distal end 110. Thus, a significantly greater amount of medicament can be withdrawn for use as compared to withdrawal by a needle in a conventional manner.

As shown generally in FIG. 1B and 1C, device 210 is configured to direct a distal end of tube 100 in a direction not perpendicular with the a plane defined by seal 50, when device is placed on or coupled to seal 50. This may be accomplished in any number of ways, one of which is shown in FIG. 1b and an alternative with is shown in FIG. 1C. For example, passage 60 may be configured to direct tube at an angle not perpendicular to seal 50. In FIG. 1B, angle 135, defined as the angle between longitudinal axis of proximal portion of passage 60 and longitudinal axis of distal portion of passage 60, may be an angle of greater than 0° to less than 90°. More specifically, angle 135 may be about 10° to about 80°, about 20° to about 70°, for example, about 30° to about 60° degrees, for example, about 40° to about 50 ° degrees. In certain embodiments of the invention, when the adapter is in use and placed in or engaged with a seal of a vial, tube 100 generally is aligned at an angle about 40° to about 80°, about 60° to about 75°, or about 65° to about 70° from a plane defined by seal 50. In these embodiments, tube 100 is sufficiently flexible to pass through bend 132 in passage 60, for example, without kinking or collapsing.

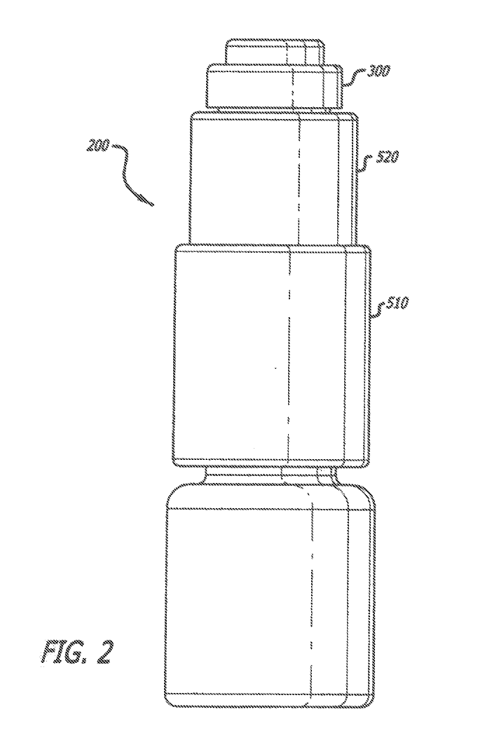

An inserter 200 may be coupled to the flexible tube 100. An inserter 200 may be any feature configured to direct the distal end 110 of the tube 100 through the passage 60, so that part of flexible tube 100 extends beyond the exit 90 of passage 60. Some inserters may be similar to an inserter 200 depicted in FIGS. 2-4, discussed below. Inserter 200 may comprise a fixed component 510 which is affixed to puncture component 10. The fixed component 510 may be an open cylinder having a platform 515 affixed toward the bottom 525 of the fixed component 510. Puncture component 10 is affixed to the platform 515 so that it extends beyond the bottom 525 of the fixed component 510. A cap 600 of a medicament bottle 650 may meet platform 515 so that puncture component 10 pierces seal 50 of cap 600.

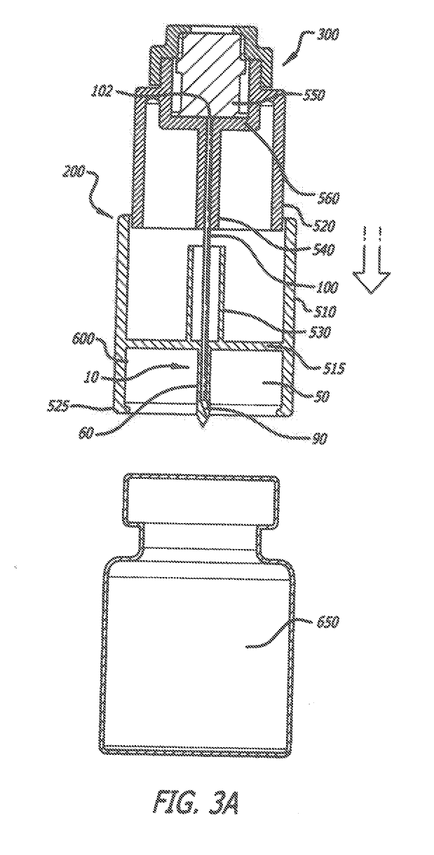

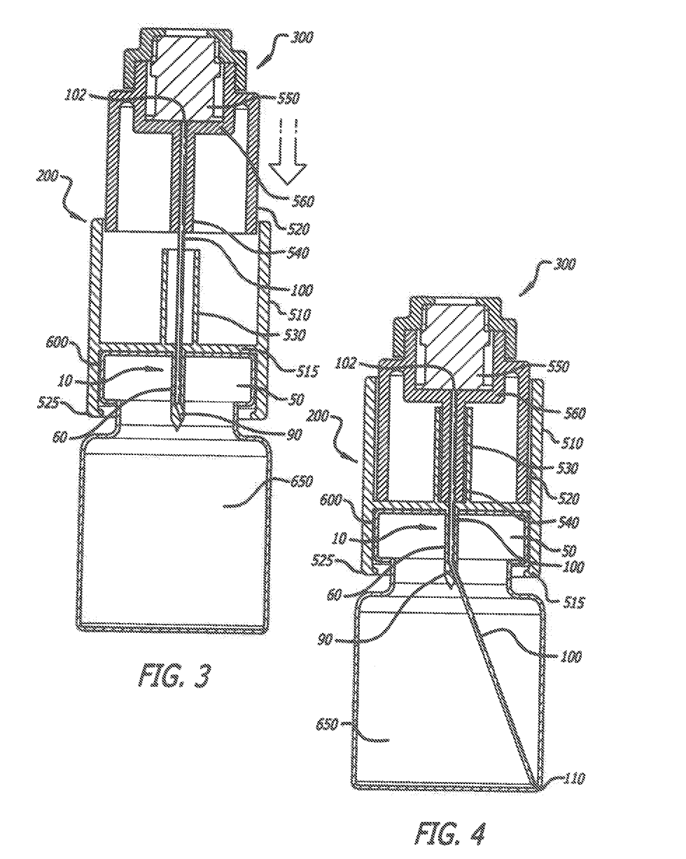

A movable component 520 is moveably coupled to the fixed component 510. Movable component 520 may be an open cylinder which slidably engages open cylinder of the fixed component 510. Moveable component 510 may comprise a ceiling 560. Ceiling 560 may be affixed to a descending guiding cylinder 540. An ascending guiding cylinder 530 may extend upward from platform 515 to guide the moveable component 520 into the fixed component 510, as shown in FIGS. 3 and 4.

Moveable component 520 is slid into fixed component 510 to a collapsed configuration, shown in FIG. 4. In an extended configuration (FIG. 3), flexible tube 100 is withdrawn from puncture component 10 such that distal end 110 of flexible tube 100 does not protrude past exit 90 of passage 60. In a collapsed configuration (FIG. 4), flexible tube 100 is extended past exit 90 of passage 60, for example, such that distal end 110 of tube 100 contacts vial corner.

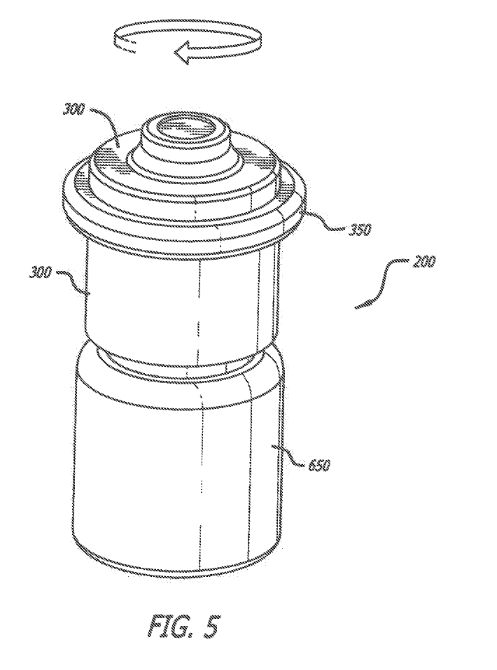

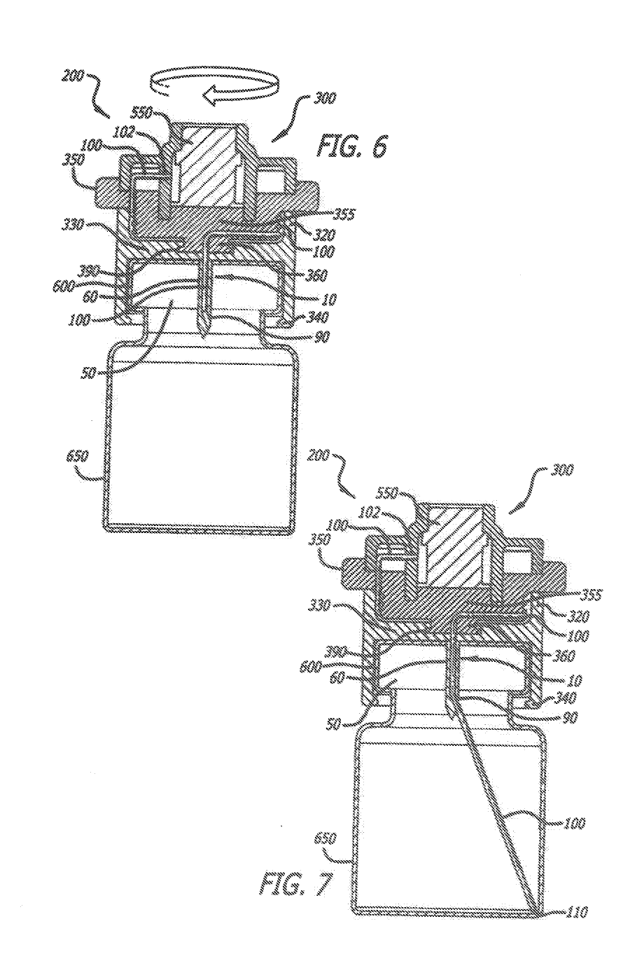

Other inserters 200 of the invention may be configured as depicted in FIGS. 5-7. Turning specifically to FIGS. 6 and 7, in this exemplary embodiment, inserter 200 comprises fixed component 320 which is affixed to puncture component 10. Fixed component 320 may be an open cylinder having a platform 330. Puncture component 10 is affixed to platform 330 so that it extends beyond the bottom 340. A cap 600 of a medicament bottle 650 may meet platform 330 so that puncture component 10 pierces seal 50 of cap 600.

Rotatable component 350 may be configured to fit inside fixed component 320 and rotate with respect to fixed component 320. Rotatable component 350 may comprise a spool component 355 which is rotatably coupled to fixed component 320. Spool component 355 may further comprise rotatable male fitting 360 that couples to fixed female fitting 390 that may be part of platform 330. Flexible tube 100 may be wrapped around spool component 355 so that rotation of rotatable component 350 inserts tube 100 through passage 60.

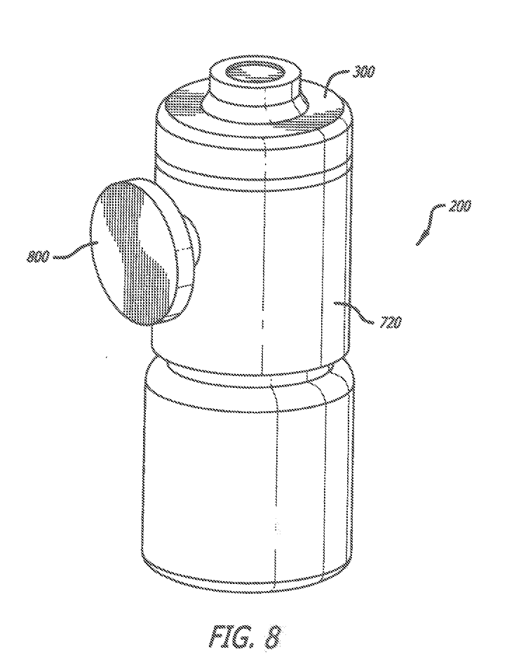

Yet other inserters 200 of the invention may be configured as depicted in FIGS. 8-10. Inserter 200 may comprise fixed component 720 which is affixed to puncture component 10. Fixed component 720 may be an open cylinder having platform 730. Puncture component 10 is affixed to platform 730 so that it extends beyond the bottom 740 of fixed component 720. A cap 600 of a medicament bottle 650 may meet platform 720 so that puncture component 10 pierces seal 50 of cap 600.

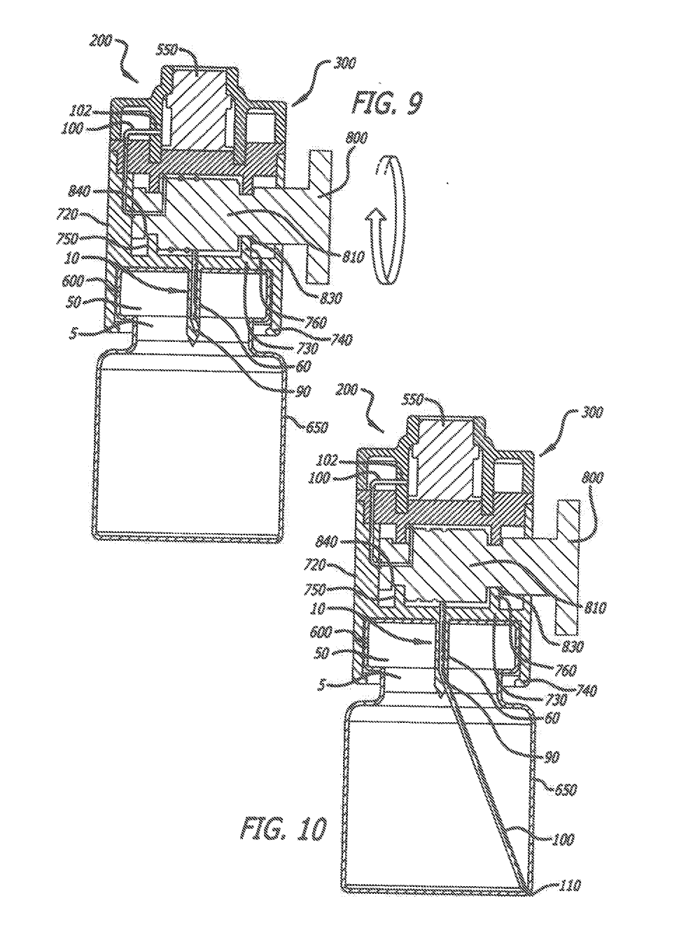

Turning specifically to FIGS. 9 and 10, rotatable component 800 may be configured to fit inside fixed component 720 and rotate with respect to fixed component 720. Rotatable component 800 may comprise a spool component 810 which is rotatably coupled to fixed component 720. Spool component 810 may further comprise rotatable spool fittings 830 and 840 that couple to fixed fittings 750 and 760 that may be part of platform 730. Flexible tube 100 may be wrapped or wound around spool component 810 so that rotation of rotatable component 800 effects distal movement and insertion of tube 100 through passage 60.

In some embodiments, the inserter includes a suitable locking mechanism to prevent retraction of the tube during insertion.

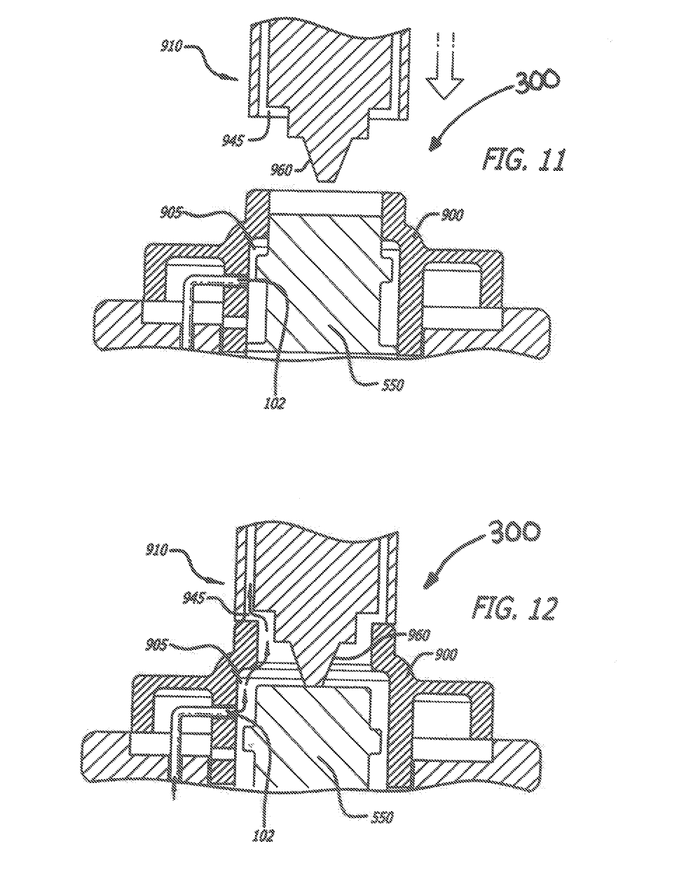

The coupling component 300 may be any structural feature configured to allow fluid communication between the proximal end 102 of the flexible tube and a means for withdrawing fluid therefrom, for example, a syringe. Exemplary coupling components 300 may be configured, for example, as depicted in FIGS. 11-12. The coupling component 300 may comprise a reservoir component 905 in fluid communication with the proximal end 102 of the flexible tube 100. A valve 550 may be coupled to the reservoir component 905. A syringe component 910 may be configured so that valve 550 is opened when the syringe component 910 is coupled to the reservoir component 905. Syringe component 910 comprises stopper 960. A gap 945 may allow flow of fluid medicament to a syringe.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

What is claimed is:

1. An adaptor device for facilitating recovery of fluid from a vial having a seal, the device comprising:
a puncture component having a cylindrical portion including a longitudinal axis, a proximal end, and a distal end configured to puncture a seal of a vial;
a passage defined in the puncture component, the passage comprising
an entrance at or near the proximal end of the puncture component,
an exit at or near the distal end of the puncture component, and
an interior portion extending from the entrance to the exit;
a flexible tube having a distal end and a proximal end; and
an inserter, coupled to the flexible tube, and configured to direct the distal end of the flexible tube through the interior portion of the passage and out of the exit of the passage and in a direction not perpendicular with the seal; and
a coupling component, configured to allow fluid communication between the proximal end of the flexible tube and a syringe.

2. The device of claim 1, wherein the interior portion of the passage includes a proximal portion and a distal portion, and an angle defined between the proximal portion and the distal portion.

3. The device of claim 2 wherein the angle is an angle of greater than 0° to less than 90°.

4. The device of claim 2 wherein the angle is an angle of between about 20° to about 70°.

5. The device of claim 2 wherein the angle is an angle of between about 30° to about 60°.

6. The device of claim 2 wherein the angle is an angle of between about 40° to about 50°.

7. The device of claim 1, wherein the device is configured to allow the flexible tube to be guided through the seal via the puncture component so that the distal end of the flexible tube to extends from the exit of the puncture component at an angle that is not perpendicular to the seal.

8. The device of claim 1 wherein the inserter comprises a fixed component and a movable component slideably coupled to the fixed component.

9. The device of claim 1 wherein the passage has an inner diameter of about 0.1 mm to about 2 mm.

10. The device of claim 1 wherein the tube has an outer diameter of about 0.05 mm to about 1.5 mm.

11. The device of claim 1 wherein the passage has an inner diameter of about 0.1 mm to about 2 mm and the tube has an outer diameter of about 0.05 mm to about 1.5 mm.

12. The device of claim 1 wherein the inserter comprises a fixed component and a rotatable component rotatably coupled to the fixed component.

13. The device of claim 12 wherein the rotatable component comprises a spool component.

14. The device of claim 13 wherein the tube is wrapped around the spool component.
